(19) United States
(12) Patent Application Publication
(10) Pub. No.: US 2010/0299134 A1
(43) Pub. Date: Nov. 25, 2010

(54) CONTEXTUAL COMMENTARY OF TEXTUAL IMAGES

(75) Inventor: Wilson Lam, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/471,257

(22) Filed: May 22, 2009

(51) Int. Cl. G06F 17/28; G06K 9/72; G10L 13/08; G01C 21/00

(52) U.S. Cl. 704/3; 382/229; 704/260; 701/207; 704/E13.001

(57) ABSTRACT

A mobile computing system includes an image capture device and an image-analysis module to receive a live stream of images from the image capture device. The image-analysis module includes a text-recognition module to identify a textual image in the live stream of images, and a text-conversion module to convert the textual image identified by the text-recognition module into textual data. The mobile computing system further includes a context module to determine a context of the textual image, and a commentary module to formulate a contextual commentary for the textual data based on the context of the textual image.

### BACKGROUND

Navigating through the world can pose serious challenges to even those who are well equipped and well prepared. Various disabilities, such as visual impairment, can greatly increase the complexity of navigation and location awareness. Landmarks, signs, and other pieces of information that many people take for granted can play a significant role in a person's ability to exist independently. The inability to appreciate such landmarks, as a consequence, can serve as an impediment to a person's independence.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

According to one aspect of the present disclosure, a mobile computing system includes an image capture device and an image-analysis module to receive a live stream of images from the image capture device. The image-analysis module includes a text-recognition module to identify a textual image in the live stream of images, and a text-conversion module to convert the textual image identified by the text-recognition module into textual data. The mobile computing system further includes a context module to determine a context of the textual image, and a commentary module to formulate a contextual commentary for the textual data based on the context of the textual image.

### BRIEF DESCRIPTION OF THE DRAWINGS

FIG. 1 somewhat schematically shows a mobile computing system audibly outputting a contextual commentary of textual images in accordance with an embodiment of the present disclosure.

FIG. 2 somewhat schematically shows a mobile computing system visually outputting a contextual commentary of textual images in accordance with an embodiment of the present disclosure.

FIG. 3 schematically shows a computing system configured to formulate contextual commentary of textual images in accordance with an embodiment of the present disclosure.

FIG. 4 shows on-screen translation of a textual image from a nonnative language to a native language.

FIG. 5 is a flowchart of a method of providing audio assistance from visual information in accordance with an embodiment of the present disclosure.

### DETAILED DESCRIPTION

Contextual commentary of textual images is disclosed. As described in more detail below with reference to nonlimiting example embodiments, a mobile computing system is configured to view a scene and search for a textual image within the scene. The mobile computing system then converts the textual image into textual data that can be processed in the same way that other text can be processed by the mobile computing system. Furthermore, the mobile computing system assesses contextual information for the textual image. The contextual information is used to formulate intelligent commentary pertaining to the textual image. The commentary is output in one or more formats which may assist a user in appreciating the textual information in the scene. In this way, with the assistance of the mobile computing system a user may be able to appreciate the information conveyed by the textual information in a scene, even though the user may not be able to rely on only her eyes to fully appreciate the information.

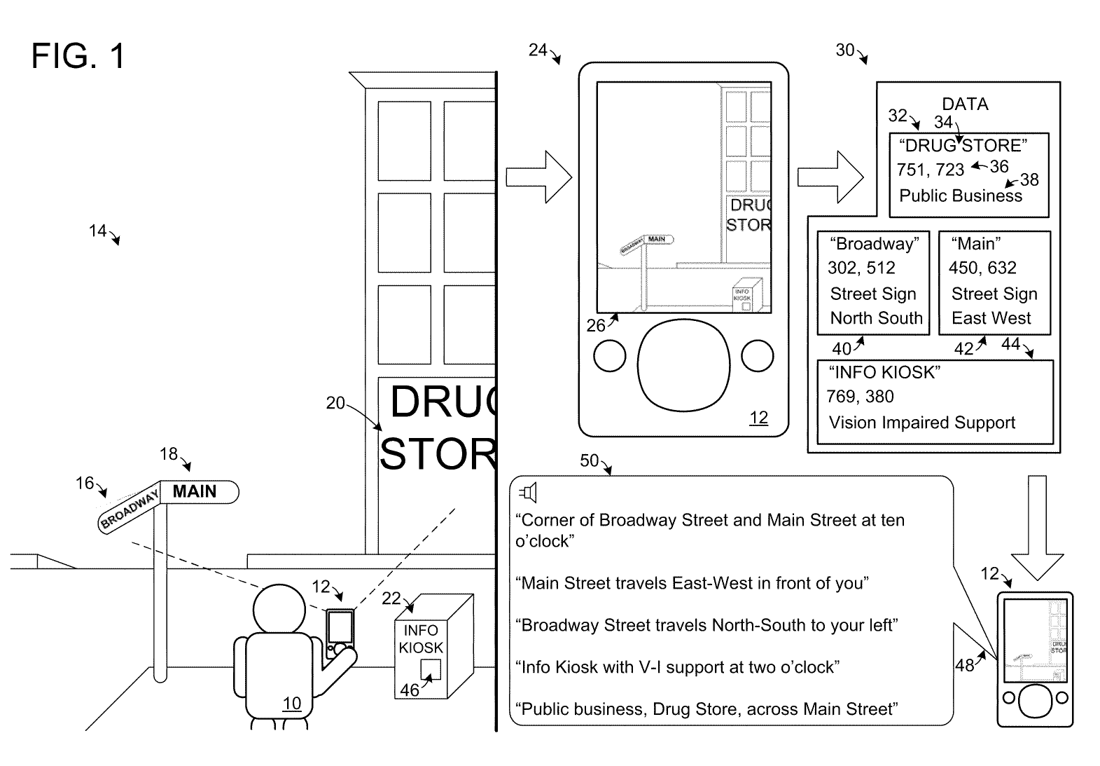

For example, FIG. 1 shows a user 10 with a mobile computing system 12. The mobile computing system 12 includes an image capture device (e.g., digital camera) that is viewing a scene 14—in this case, the intersection of two roads in a city. In the illustrated embodiment, scene 14 includes four different textual images, namely street sign 16, street sign 18, shop sign 20, and kiosk sign 22. Scene 14 and the illustrated textual images are provided as a nonlimiting example intended to demonstrate the herein described contextual commentary of textual images. It is to be understood that the principles described below with reference to scene 14 may be applied to a wide variety of different textual images in a wide variety of different contexts.

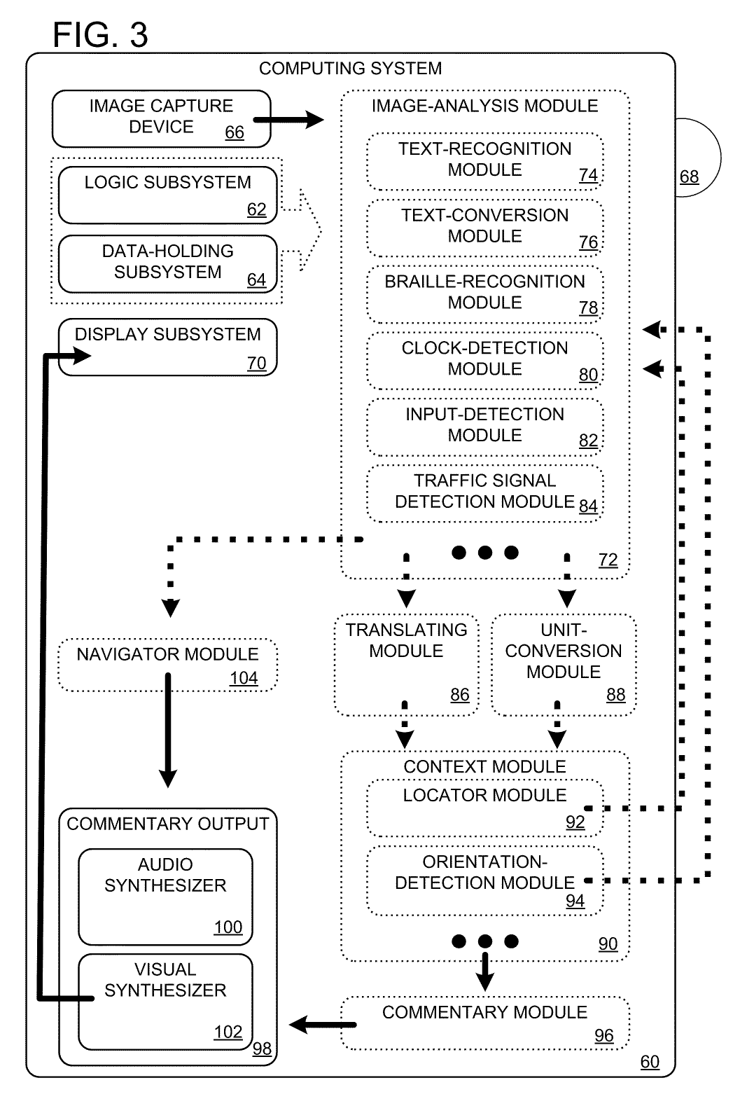

As shown at 24, mobile computing system 12 includes a display 26 that shows a live stream of images viewed by the image capture device. As described in more detail below with reference to FIG. 3, a computing system may be configured to identify one or more textual images in the live stream of images and to convert each such textual image into textual data. As used herein, textual data is used to generally refer to any data type characterized by an alphabet (e.g., a string data type). Many such data types will use a code for referring to each different character in an alphabet. In this way, words, sentences, paragraphs, or other collections of the characters can be easily and efficiently stored and/or processed. This is in contrast to textual images in which an image including a picture of one or more characters is represented in the same manner that other pictures are represented, usually by specifying one or more color values for each pixel in the image, either in an uncompressed (e.g., bitmap) or compressed (e.g., JPEG) format.

FIG. 1 schematically shows data 30 derived from the textual images of scene 14. In particular, data 30 includes package 32 corresponding to shop sign 20. Package 32 includes textual data 34, positional data 36 specifying the position of shop sign 20 in scene 14, and contextual data 38 specifying an assessed context of the textual image. Similarly, package 40 includes textual data corresponding to street sign 16, positional data specifying the position of street sign 16 in scene 14, and contextual data specifying an assessed context of the textual image; package 42 includes textual data corresponding to street sign 18, positional data specifying the position of street sign 18 in scene 14, and contextual data specifying an assessed context of the textual image; and package 42 includes textual data corresponding to kiosk sign 22, positional data specifying the position of kiosk sign 22 in scene 14, and contextual data specifying an assessed context of the textual image.

As described in more detail below, the mobile computing system may be configured to assess a context of a textual image. A context may be assessed using a variety of different approaches, nonlimiting examples of which are described below. With reference to scene 14, for example, the textual data 34 (i.e., “drug store”) corresponding to shop sign 20 may be searched in a local or networked database to find a match. In some embodiments, the mobile computing system may include a GPS or other locator for determining a position of the mobile computing system. When included, the mobile computing system can intelligently search a local or networked database for entries at or near the location of the mobile computing system. In some embodiments, the mobile computing system may include a compass, which may be used in cooperation with a locator to better estimate an actual position of the textual image.

When the mobile computing system is able to find a match for the textual data in a local or networked database, the mobile computing system may extract information from the database, and a context of the textual image may be derived from such information. For example, the name and position of “Drug Store” may match a public business with an Internet listing. As such, the mobile computing system may associate context data 38 with textual data 34 to signify that the textual image of shop sign 20 is associated with a public business.

As another example, the mobile computing system may be configured to analyze the live stream of images in accordance with a variety of different entity extraction principles, each of which may be used to assess a context of a textual image. Different characteristics can be associated with different contexts. As a nonlimiting example, a textual image with white characters surrounded by a substantially rectangular green field may be associated with a street sign. When a GPS or other locator is included, a street sign context can be verified by determining if a particular street, or intersection, is located near the mobile computing system.

As an example, street sign 16 and street sign 18 may both have white characters surrounded by a green field, or other visual characteristics previously associated with street signs. Therefore, the mobile computing system may use contextual data to signify that the textual images of street sign 16 and street sign 18 are associated with street signs. This assessment may be verified using GPS or other positioning information. Furthermore, the GPS data may be used to determine which directions the streets travel at the location of the mobile computing system, and the mobile computing system may associate this directional information with the context data.

As yet another example, kiosk sign 22 includes an identifier 46. Such an identifier may include an icon, logo, graphic, digital watermark, or other piece of visual information that corresponds to a particular context. As an example, identifier 46 may be used to signal that the item on which the identifier is placed includes Braille. As another example, an identifier including a wheelchair logo may be used to signal that a location is handicap accessible. The mobile computing system may associate context data with textual data to signify that the textual image of kiosk sign 22 is associated with a facility with support for the vision impaired.

Mobile computing system 12 can use data 30 to formulate a contextual commentary for the textual data based on the context of the textual image. In some embodiments, the mobile computing system may formulate each such commentary independently of other such commentaries. In some embodiments, the mobile computing system may consider two or more different textual images together to formulate a commentary.

As indicated at 48, mobile computing system 12 may output the contextual commentary as an audio signal, which may be played by a speaker, headphone, or other sound transducer. Box 50 schematically shows the audible sounds resulting from such an audio signal. Audio sounds can be played in real time as the mobile computing system recognizes the textual images, converts the textual images into textual data, and formulates contextual commentaries for the textual data based on the determined context of the textual images. In some embodiments, the mobile computing system may include controls that allow a user to skip commentaries and/or repeat commentaries. In some embodiments, the mobile computing system may include one or more user settings or filters that cause commentaries having a specific context to be given a higher priority than other commentaries with different contexts (e.g., street sign commentaries played before shop sign commentaries).

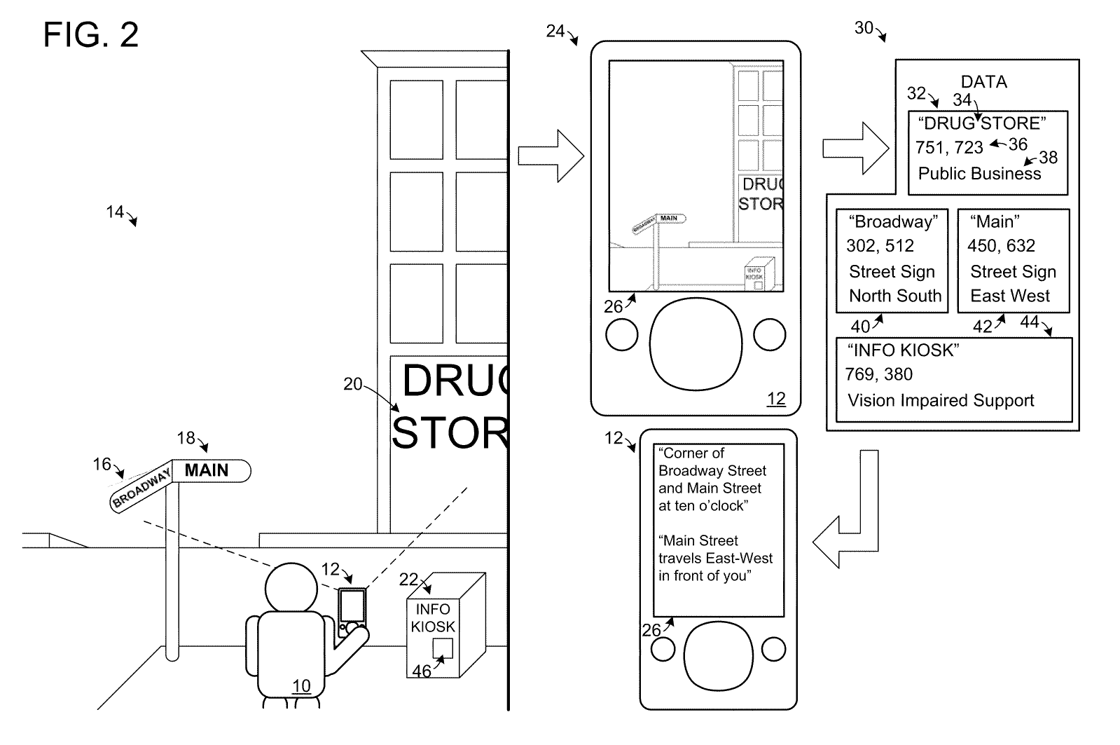

FIG. 1 shows an example in which the commentaries are played as audio sounds. In some embodiments, a mobile computing system may be configured to output the commentaries in other formats. As a nonlimiting example, FIG. 2 shows a scenario similar to the scenario of FIG. 1, but where a mobile computing system 12 is configured to output the commentaries via display 26. When output as an image via a display, the size, color, contrast, and other characteristics of the image may be tailored to facilitate reading by the visually impaired.

The commentaries may be output in any other suitable manner without departing from the spirit of this disclosure. Furthermore, while described as a tool capable of assisting the visually impaired, it should be understood that the herein described contextual commentary of textual images may be performed with a variety of different motivations. The present disclosure is not in any way limited to devices configured to assist the visually impaired.

The contextual commentary of textual images, as introduced above, can be performed by a variety of differently configured computing systems without departing from the spirit of this disclosure. As an example, FIG. 3 schematically shows a computing system 60 that may perform one or more of the herein described methods and processes for formulating contextual commentaries for textual images. Computing system 60 includes a logic subsystem 62, a data-holding subsystem 64, and an image capture device 66. Computing system 60 may optionally include a display subsystem and/or other components not shown in FIG. 3.

Logic subsystem 62 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Data-holding subsystem 64 may include one or more physical devices configured to hold data and/or instructions executable by the logic subsystem to implement the herein described methods and processes. When such methods and processes are implemented, the state of data-holding subsystem 64 may be transformed (e.g., to hold different data). Data-holding subsystem 64 may include removable media and/or built-in devices. Data-holding subsystem 64 may include optical memory devices, semiconductor memory devices, and/or magnetic memory devices, among others. Data-holding subsystem 64 may include devices with one or more of the following characteristics: volatile, nonvolatile, dynamic, static, read/write, read-only, random access, sequential access, location addressable, file addressable, and content addressable. In some embodiments, logic subsystem 62 and data-holding subsystem 64 may be integrated into one or more common devices, such as an application specific integrated circuit or a system on a chip.

FIG. 3 also shows an aspect of the data-holding subsystem in the form of computer-readable removable media 68, which may be used to store and/or transfer data and/or instructions executable to implement the herein described methods and processes.

Image capture device 66 may include optics and an image sensor. The optics may collect light and direct the light to the image sensor, which may convert the light signals into electrical signals. Virtually any optical arrangement and/or type of image sensor may be used without departing from the spirit of this disclosure. As an example, an image sensor may include a charge-coupled device or a complementary metal—oxide—semiconductor active-pixel sensor.

When included, a display subsystem 70 may be used to present a visual representation of data held by data-holding subsystem 64. As the herein described methods and processes change the data held by the data-holding subsystem, and thus transform the state of the data-holding subsystem, the state of display subsystem 70 may likewise be transformed to visually represent changes in the underlying data. Display subsystem 70 may include one or more display devices utilizing virtually any type of technology. Such display devices may be combined with logic subsystem 62 and/or data-holding subsystem 64 in a shared enclosure, or such display devices may be peripheral display devices.

The term “module” may be used to describe an aspect of computing system 60 that is implemented to perform one or more particular functions. In some cases, such a module may be instantiated via logic subsystem 62 executing instructions held by data-holding subsystem 64. In some cases, such a module may include function-specific hardware and/or software in addition to the logic subsystem and data holding subsystem (e.g., a locator module may include a GPS receiver and corresponding firmware and software). It is to be understood that different modules may be instantiated from the same application, code block, object, routine, and/or function. Likewise, the same module may be instantiated by different applications, code blocks, objects, routines, and/or functions in some cases.

Computing system 60 may include an image-analysis module 72 configured to receive a live stream of images from the image capture device 66. The image-analysis module may include a text-recognition module 74, a text-conversion module 76, a Braille-recognition module 78, a clock-detection module 80, an input-detection module 82, and/or a traffic signal detection module 84.

Text-recognition module 74 may be configured to identify a textual image in a live stream of images received from the image capture device 66. Furthermore, the text-recognition module may be configured to identify a textual image in discrete images received from the image capture device and/or another source.

Text-conversion module 76 may be configured to convert the textual image identified by the text-recognition module into textual data (e.g., a string data type). The text-recognition module 74 and the text-conversion module may collectively employ virtually any optical character recognition algorithms without departing from the spirit of this disclosure. In some embodiments, such algorithms may be designed to detect texts having different orientations in the same view. In some embodiments, such algorithms may be designed to detect texts utilizing different alphabets in the same view. The text-conversion module may optionally include a spell checker to automatically correct a spelling mistake in a textual image.

In some embodiments, the image-analysis module 72 may be configured to allow color filtering and/or other selective detections. For example, a user may select to ignore all black-on-white text and only output blue-on-white text. In other embodiments, contextual commentaries may be used to signal hyperlinks or other forms of text. As another example, the image-analysis module may be configured to only detect and/or report street signs, company names, particular user-selected word(s), or other texts based on one or more selection criteria. As another example, the image-analysis module may be configured to accommodate priority tracking, so that a user may set selected texts (e.g., particular bus numbers) to trigger an alarm or initiate another action upon detection of the selected text.

The image-analysis module may utilize a buffer and/or cache that allows images from two or more frames to be collectively analyzed for detection of a textual image. For example, when a piece of text is too wide to be captured in the field of view of the image capture device, the user may pan the device to capture the textual image in two or more frames and the image-analysis module may effectively stitch the textual image together. In some embodiments, an accelerometer of the computing system may be used to detect relative movements of the computing system and facilitate such image stitching.

The image-analysis module may be configured to analyze a live stream of images in accordance with entity extraction principles associated with various different types of contextual information, such as a location identified by location data.

In some embodiments, computing system 60 may include a traffic signal detection module 84. In such cases the computing system may be configured to include a status of a detected traffic signal as part of a contextual commentary associated with a street sign and/or as a contextual commentary independently associated with the traffic signal. In this way, the computing system may notify a user whether or not it is safe to cross a street.

In some embodiments, computing system 60 may include an input-detection module 82 configured to recognize an input device (e.g., keyboard) including one or more textual images (e.g., keys with letter characters). The input-detection module 82 may be configured to detect common keyboard or other input device patterns (e.g., QWERTY, DVORAK, Ten-key, etc.). In this way, the computing system may formulate a contextual commentary notifying a user of a particular input device so that the user may better operate that input device.

In some embodiments, computing system 60 may include a clock-detection module 80 configured to recognize a clock including hour-indicating numerals arranged in a circle or other known clock pattern (e.g., oval, square, rectangle, etc.). The clock-detection module may be further configured to read the time based on the hand position of the clock relative to the hour-indicating numerals.

In some embodiments, computing system 60 may include a Braille-recognition module 78 configured to identify a Braille image in the live stream of images. The Braille-recognition module may include a Braille-conversion module to convert the Braille image identified by the Braille-recognition module into textual data, which can be vocalized, output as text on a display, and/or for which a contextual commentary may be formulated.

In some embodiments, computing system 60 may include a translating module 86 to convert a textual image of a nonnative language into textual data of a native language. For example, a user may specify that all textual data should be in the user's native language (e.g., English). If nonnative textual images are detected, the translating module may convert the textual images into native textual data and/or the translating module may be configured to convert nonnative textual data into native textual data.

In some embodiments, the textual data in the native language can be displayed as an enhancement to the textual image of the nonnative language. That is, a native language version of a word can be displayed in place of, next to, over, as a callout to, or in some other relation relative to the textual image of the nonnative language. In this way, a user can view a display of the mobile computing device and read, in a native language, those signs and other textual items that are written in a nonnative language.

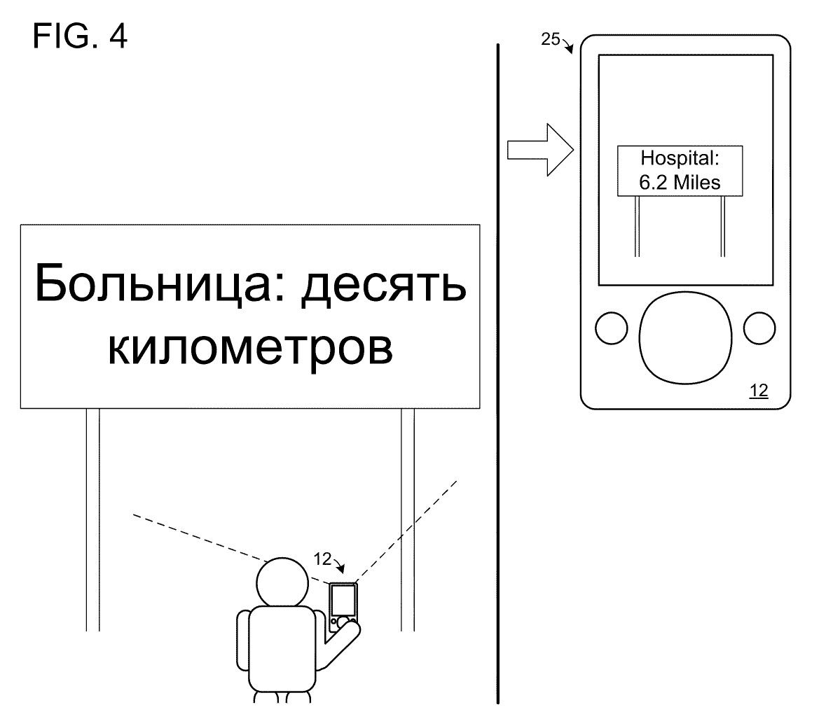

FIG. 4 somewhat schematically shows mobile computing device 12 providing on-screen translations. In particular, mobile computing device 12 is viewing a scene that includes a sign written in Russian. The English translation of the sign is: “Hospital: Ten Kilometers.” As shown at 25, mobile computing device 12 displays the scene, but replaces the Russian textual image with an English textual image.

Returning to FIG. 3, computing system 60 may include a unit-conversion module 88 to convert textual data having a numeric value associated with a first unit to textual data having a numeric value associated with a second unit. In such cases, the commentary module may be configured to formulate the contextual commentary for the textual data having the numeric value associated with the second unit. In this way, a user may be provided with commentaries that are more easily understandable. As an example, when unit conversion is enabled, “60 miles” may be output when “100 km” is detected, or “1 US dollar” my be output if “100 yen” is detected, or “9:00 pm” may be output if “21:00” is detected. Further, as shown in FIG. 4, the converted numeric value may be displayed as an enhancement to the textual image with the unconverted units. Also, as demonstrated in FIG. 4, a number spelled out may be converted to a number written with numerals, or vice versa (e.g., ten to 10, or 10 to ten).

In some embodiments, computing system 60 may include a context module 90 configured to determine a context of the textual image. The Braille-recognition module 78, clock-detection module 80, input-detection module 82, and traffic signal detection module 84 described above provide nonlimiting examples of context modules. As shown in FIG. 3, such context modules may optionally be components of the image-analysis module 72.

FIG. 3 also shows a locator module 92 configured to determine location data identifying a location of the mobile computing system. The locator module may include hardware (e.g., GPS receiver) and/or software (maps, location database, etc.) for identifying a location of the mobile computing system, or the locator module may receive location data as reported from another source (e.g., a peripheral GPS). The locator module may further be configured to load entity extraction data for different locals (e.g., different street sign designs for different countries, different license plate designs for different states, etc.) to facilitate recognition of textual images and/or to facilitate formulation of intelligent contextual commentaries.

The computing system may include an orientation-detection module 94 to determine orientation data identifying a directional orientation of the image capture device. When used cooperatively with the locator module, the directional orientation of the device (i.e., which direction the image capture device is pointing) may be used to more accurately estimate the location of various textual images.

Computing system 60 includes a commentary module 96 configured to formulate a contextual commentary for the textual data based on the context of the textual image. As an example, the commentary module may include information derived from the location data in the contextual commentary. FIG. 1 provides five examples of such commentaries, namely “corner of Broadway Street and Main Street at ten o-clock,” “Main Street travels East-West in front of you,” “Broadway Street travels North-South to your left,” Info Kiosk with V-I support at two “o'clock,” and “Public business, Drug Store, across Main Street.” As can be seen by way of these examples, the commentary module provides intelligent commentary relating to the textual images as opposed to merely reciting the detected text verbatim without any contextual commentary. Such commentary may be extremely useful, for example, to a visually impaired person that may not otherwise be able to appreciate the full context of their current environment.

Computing system 60 may include one or more outputs 98 for audibly, visually, or otherwise presenting the commentaries to a user. In the illustrated embodiment, computing system 60 includes an audio synthesizer 100 configured to output the contextual commentary as an audio signal and a visual synthesizer 102 to output the contextual commentary as a video signal.

Computing system 60 may include a navigator module 104 configured to formulate navigation directions to a textual image. The navigator module may cooperate with the commentary module to provide directions to a textual image as part of the contextual commentary (e.g., “corner at ten o'clock,” “Main Street in front of you,” etc.). The navigator module may utilize text motion tracking, allowing the user to set a detected textual image as a destination and let the device provide directions to the textual image (e.g., by giving directions that keep the textual image towards a center of the field of view). The navigator module may also cooperate with locator module 92 to provide directions.

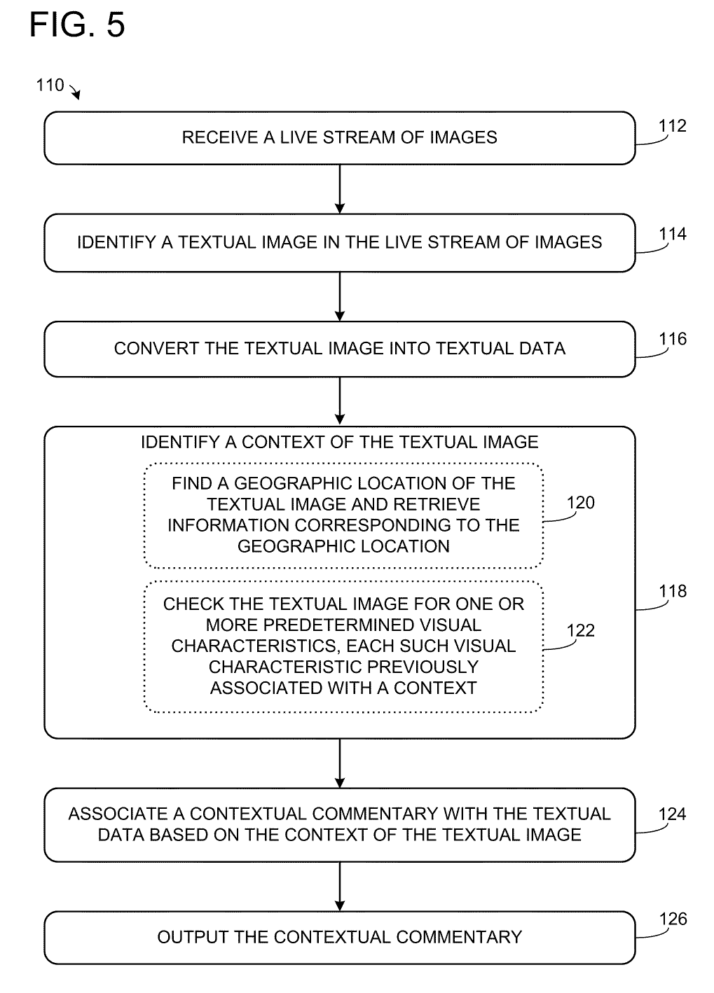

FIG. 5 shows a method 110 of providing audio assistance from visual information in accordance with the above disclosure. At 112, method 110 includes receiving a live stream of images. At 114, method 110 includes identifying a textual image in the live stream of images. At 116, method 110 includes converting the textual image into textual data. At 118, method 110 includes identifying a context of the textual image. As an example, at 120 this may include finding a geographic location of the textual image and retrieving information corresponding to the geographic location. As another example, at 122 this may include checking the textual image for one or more predetermined visual characteristics, each such visual characteristic previously associated with a context. At 124, method 110 includes associating a contextual commentary with the textual data based on the context of the textual image. At 126, method 110 includes outputting the contextual commentary.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A mobile computing system, comprising: an image capture device;
an image-analysis module to receive a live stream of images from the image capture device, the image-analysis module including:
a text-recognition module to identify a textual image of a nonnative language in the live stream of images; and
a translating module to convert the textual image identified by the text-recognition module into textual data of a native language; and
a visual synthesizer to display the textual image of the native language as an enhancement to the textual image of the nonnative language.

2. The mobile computing system of claim 1, further comprising:
a locator module to determine location data identifying a location of the mobile computing system;
a commentary module to formulate a contextual commentary for the textual data based on the location data; and
an audio synthesizer to output the contextual commentary as an audio signal.

3. The mobile computing system of claim 2, further comprising
an orientation-detection module to determine orientation data identifying a directional orientation of the image capture device.

4. The mobile computing system of claim 2, where the commentary module further formulates the contextual commentary for the textual data based on the orientation data.

5. The mobile computing system of claim 2, further comprising
a navigator module configured to formulate navigation directions to the textual image.

6. The mobile computing system of claim 2, where the image-analysis module is configured to analyze the live stream of images in accordance with entity extraction principles associated with the location identified by the location data.

7. A mobile computing system, comprising:
an image capture device;
an image-analysis module to receive a live stream of images from the image capture device, the image-analysis module including:
a text-recognition module to identify a textual image in the live stream of images; and
a text-conversion module to convert the textual image identified by the text-recognition module into textual data;
a context module to determine a context of the textual image; and
a commentary module to formulate a contextual commentary for the textual data based on the context of the textual image.

8. The mobile computing system of claim 7, where the context module includes a locator module to determine a location of the mobile computing system.

9. The mobile computing system of claim 8, where the commentary module is configured to include information derived from the location in the contextual commentary.

10. The mobile computing system of claim 7, where the image-analysis module includes an input-detection module to recognize in the live stream of images an input device including one or more textual images.

11. The mobile computing system of claim 7, where the image-analysis module includes a clock-detection module to recognize in the live stream of images a clock including hour-indicating numerals arranged in a circle.

12. The mobile computing system of claim 7, where the image-analysis module further includes a Braille-recognition module to identify a Braille image in the live stream of images and a Braille-conversion module to convert the Braille image identified by the Braille-recognition module into textual data.

13. The mobile computing system of claim 7, where the text-conversion module is configured to convert the textual image into textual data having a string data type.

14. The mobile computing system of claim 7, further comprising an audio synthesizer to output the contextual commentary as an audio signal.

15. The mobile computing system of claim 7, further comprising a visual synthesizer to output the contextual commentary as a video signal.

16. The mobile computing system of claim 7, further comprising a translating module to convert a textual image of a nonnative language into textual data of a native language.

17. The mobile computing system of claim 7, further comprising a unit-conversion module to convert textual data having a numeric value associated with a first unit to textual data having a numeric value associated with a second unit, and where the commentary module is configured to formulate the contextual commentary for the textual data having the numeric value associated with the second unit.

18. A method of providing audio assistance from visual information, the method comprising:
receiving a live stream of images;
identifying a textual image in the live stream of images;
identifying a context of the textual image;
converting the textual image into textual data;
associating a contextual commentary with the textual data based on the context of the textual image; and
outputting the contextual commentary.

19. The method of claim 18, where identifying a context of the textual image includes finding a geographic location of the textual image and retrieving information corresponding to the geographic location.

20. The method of claim 18, where identifying a context of the textural image includes checking the textual image for one or more predetermined visual characteristics, each such visual characteristic previously associated with a context.
